(19) United States
(12) Patent Application Publication
(10) Pub. No.: US 2013/0025547 A1
(43) Pub. Date: Jan. 31, 2013

(54) FUEL SUPPLY SYSTEM

(71) Applicants: Tadahiro NAKAGAWA, Nisshin-city (JP); Takuya Fuse, Nagoya-city (JP); Kazutoshi Kuwayama, Kariya-city (JP)

(72) Inventors: Tadahiro NAKAGAWA, Nisshin-city (JP); Takuya Fuse, Nagoya-city (JP); Kazutoshi Kuwayama, Kariya-city (JP)

(73) Assignee: DENSO CORPORATION, Kariya-city (JP)

(21) Appl. No.: 13/557,411

(22) Filed: Jul. 25, 2012

(30) Foreign Application Priority Data
Jul. 27, 2011 (JP) 2011-164243

(51) Int. Cl. F02B 43/10; F01N 5/02; F02M 31/20

(52) U.S. Cl. 123/3; 123/541; 60/320

(57) ABSTRACT

A fuel supply system includes an energy output device, a reformer and a cooling unit. The energy output device consumes fuel, which is a compound including hydrogen, and outputs energy. The reformer decomposes fuel so as to generate hydrogen which is to be supplied to the energy output device. The cooling unit cools the hydrogen generated in the reformer.

### CROSS REFERENCE TO RELATED APPLICATION

This application is based on and incorporates herein by reference Japanese Patent Application No. 2011-164243 filed on Jul. 27, 2011.

### TECHNICAL FIELD

The present disclosure relates to a fuel supply system which decomposes hydrogen-containing fuel to generate hydrogen and supplies the generated hydrogen to an energy output device as supplemental fuel.

### BACKGROUND

Conventionally, a fuel supply system including an ammonia decomposition portion and an ammonia oxidization portion is disclosed in, for example, JP 2010-269965 A. The ammonia decomposition portion decomposes ammonia under an influence of an ammonia decomposition catalyst to generate hydrogen, and the ammonia decomposition portion is thereby used as a reformer which decomposes ammonia fuel to generate hydrogen. The ammonia oxidization portion is located upstream of the ammonia decomposition portion in an ammonia flow direction to oxidize the ammonia under an influence of an ammonia oxidization catalyst.

In the conventional technology described in JP 2010-269965 A, a carrier is oxidized to generate heat by using the ammonia oxidization catalyst, and the generated heat induces an oxidization reaction of the ammonia. Heat generated in the oxidization reaction of the ammonia can be used in the ammonia decomposition portion located downstream of the ammonia oxidization portion in the ammonia flow direction. Accordingly, in the decomposition process of the ammonia, a step of preheating the ammonia by using an electric heater or the like can be omitted, and hydrogen can be thereby generated in a low cost.

In the conventional technology described in JP 2010-269965 A, because a temperature of the hydrogen supplied from the reformer to an engine used as an energy output device becomes high, a density of fuel supplied to the engine is reduced. Thus, a compression ratio of the engine may decrease, and an efficiency of the engine may thereby reduce.

Moreover, in the conventional technology described in JP 2010-269965 A, a part of the fuel supplied to the reformer is oxidized (combusted) to generate heat, and the conventional technology uses this heat for the decomposition of fuel. In other words, the fuel is oxidized partially before being supplied to the engine. Hence, the efficiency of the engine may be reduced.

Additionally, the conventional technology described in JP 2010-269965 A has a configuration in which air is mixed into a fuel supply passage through which fuel is supplied to the engine. Hence, water vapor and nitrogen are generated in the reformer by combusting the fuel (ammonia), and a large amount of the generated water vapor and nitrogen are supplied to the engine. Therefore, the compression ratio of the engine may be thereby difficult to enhance. As a result, the efficiency of the engine cannot be increased.

### SUMMARY

According to an aspect of the present disclosure, a fuel supply system includes an energy output device, a reformer and a cooling unit. The energy output device is configured to consume fuel, which is a compound including hydrogen, and to output energy. The reformer is configured to decompose fuel so as to generate hydrogen which is to be supplied to the energy output device. The cooling unit is configured to cool the hydrogen generated in the reformer.

### BRIEF DESCRIPTION OF THE DRAWINGS

The disclosure, together with additional objectives, features and advantages thereof, will be best understood from the following description, the appended claims and the accompanying drawings, in which:

FIG. 1 is a diagram showing an entire configuration of a fuel supply system according to a first embodiment;

FIG. 2 is a diagram showing an entire configuration of a fuel supply system according to a second embodiment;

FIG. 3 is a diagram showing an entire configuration of a fuel supply system according to a third embodiment;

FIG. 4 is a diagram showing an entire configuration of a fuel supply system according to a fourth embodiment;

FIG. 5 is a diagram showing an entire configuration of a fuel supply system according to a fifth embodiment;

FIG. 6 is a diagram showing an entire configuration of a fuel supply system according to a sixth embodiment;

FIG. 7 is a perspective view showing a heat exchanger for the fuel supply system according to the sixth embodiment;

FIG. 8 is an exploded view showing a portion X in FIG. 7; and

FIG. 9 is a diagram showing an entire configuration of a fuel supply system of a modification.

### DETAILED DESCRIPTION

Embodiments will be described hereinafter referring to drawings. A component same as or equivalent to a component described in a preceding embodiment may be assigned the same numeral as a numeral of the component described in the preceding embodiment in the drawings, and redundant explanation for the component may be omitted.

### First Embodiment

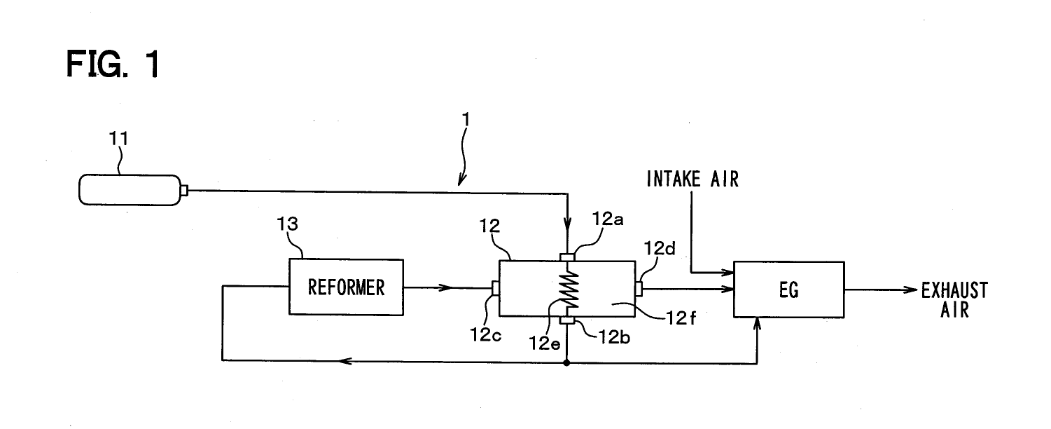

A first embodiment will be described with reference to FIG. 1. A fuel supply system 1 of the first embodiment is used for a vehicle, and supplies fuel to an internal combustion engine EG of the vehicle. The engine EG is used as an energy output device which outputs a driving force for vehicle running. The fuel supply system 1 includes a high pressure tank 11 as a liquid-fuel storage portion which accumulates therein a high-pressure liquid fuel having been pressurized and liquefied.

Fuel stored in the high pressure tank 11 has flammability to be burned in the engine EG, and may be easy to liquefy at ordinary temperature (approximately from 15° C. to 25° C.) and at high pressure in order to reduce a cost for manufacturing the high pressure tank 11.

In the present embodiment, ammonia (NH₃) is used as the fuel for the fuel supply system 1 because ammonia has the flammability and can be liquefied and under a pressure equal to or lower than 1.5 MPa even at ordinary temperature. Moreover, ammonia can be reformed to generate hydrogen gas having flammability because ammonia is a fuel (compound) containing hydrogen.

In addition, for example, fuel containing dimethyl ether or alcohol has a characteristic equivalent to ammonia, and may be thereby used as the fuel for the fuel supply system 1 alternatively. Furthermore, fuel containing hydrogen and at least one atomic element of sulfur (S), oxygen (O), nitrogen (N), and halogen, and developing an intermolecular hydrogen bond therein may be used as the fuel for the fuel supply system 1. Besides this, propane may be used as the fuel alternatively.

A fuel outflow port of the high pressure tank 11 is connected to a fuel inflow port 12a of a gasifier 12. The gasifier 12 of the present embodiment is a gasification heat exchanger in which liquid fuel (fuel in a liquid phase state) flowing out of the high pressure tank 11 is heated and gasified through heat exchange with hydrogen gas introduced into the gasifier 12 via a hydrogen inflow port 12c described later. Specifically, the gasifier 12 includes a fuel passage 12e through which fuel passes, and a hydrogen gas passage 12f through which hydrogen gas passes.

The fuel (gas fuel) in a gas phase state, gasified in the gasifier 12, flows out of the gasifier 12 through a fuel outflow port 12b of the gasifier 12. The flow of the gas fuel flowing out of the gasifier 12 through the fuel outflow port 12b is divided into two flows. One of the two branched flows of the gas fuel is directed to enter into a fuel injection valve (injector) which injects and supplies the gas fuel to a combustion chamber of the engine EG, and the other one of the two flows of the gas fuel is directed to enter into a reformer 13 which reforms the gas fuel to generate hydrogen gas.

The reformer 13 heats the gas fuel to a fuel-reformable temperature, above which the gas fuel is reformable, under an influence of a catalyst, so as to reform the gas fuel and to generate hydrogen gas. Specifically, in the present embodiment, because ammonia containing hydrogen is used as the fuel for the fuel supply system 1, the fuel is heated at a temperature from 300° C. to 700° C. so that the fuel is reformed under an influence of the catalyst to generate hydrogen gas. In the present embodiment, an electric heater (not shown) is used as heating means which heats the gas fuel to the fuel-reformable temperature.

A hydrogen outflow port of the reformer 13 is connected to the hydrogen inflow port 12c of the gasifier 12. In the gasifier 12, as described above, liquid fuel flowing out of the high pressure tank 11 exchanges heat with hydrogen gas introduced into the gasifier 12 via the hydrogen inflow port 12c of the gasifier 12. Here, the liquid fuel is heated, and the hydrogen gas is cooled at the same time in the gasifier 12 through the heat exchange between the liquid fuel and the hydrogen gas.

When the liquid fuel flowing out of the high pressure tank 11 is gasified, a latent heat of vaporization of the liquid fuel is absorbed from the hydrogen gas flowing through the gasifier 12, and the hydrogen gas is thereby cooled. Here, the fuel is heated by absorbing heat of the hydrogen gas, and vaporization of the fuel is promoted.

Thus, the gasifier 12 is used also as a cooling unit which cools hydrogen gas generated in the reformer 13 and lets the cooled hydrogen gas flow to the engine EG. In the present embodiment, because ammonia, which is hydrogen-containing fuel, is used as the fuel for the fuel supply device 1, the hydrogen gas is cooled to have a temperature from −40° C. to 300° C.

A hydrogen outflow port 12d of the gasifier 12 is connected to an intake air port of the engine EG. Hence, hydrogen gas generated in the reformer 13 and cooled in the gasifier 12 is mixed with intake air and is supplied as supplemental fuel to the combustion chamber through the intake air port of the engine EG.

In the present embodiment, the gasifier 12 used as the cooling unit is capable of cooling hydrogen gas generated in the reformer 13. Thus, the hydrogen gas to be supplied to the engine EG can be reduced in temperature. Accordingly, fuel to be supplied to the engine EG can be increased in density, and a compression ratio can be thereby increased. Consequently, an efficiency of the engine EG can be improved. Moreover, by using the gasifier 12 as the cooling unit, the hydrogen gas to be supplied to the engine EG can be reduced in temperature without additional energization from outside.

In the present embodiment, the hydrogen gas is cooled by using the latent heat of vaporization of fuel in the gasifier 12, and ammonia is used as the fuel for the fuel supply system 1. Because ammonia generally has a relatively high latent heat of vaporization, the hydrogen gas can be cooled sufficiently.

Furthermore, in the present embodiment, gas fuel heated by absorbing the heat of the hydrogen gas in the gasifier 12 flows into the reformer 13. Hence, the gas fuel can be reformed on an inlet side of the reformer 13, in other words, the gas fuel can be reformed in an entire inside space of the reformer 13.

### Second Embodiment

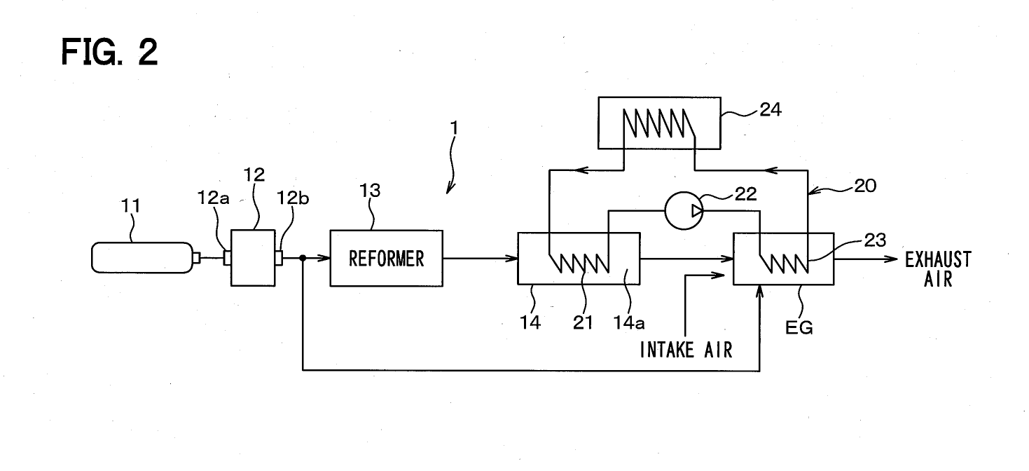

A second embodiment will be described referring to FIG. 2. The second embodiment is different from the above-described first embodiment in a point where, a cooling heat exchanger 14 of an engine cooling system is used as the cooling unit which cools hydrogen gas generated in a reformer 13.

A gasifier 12 of the second embodiment gasifies high-pressure liquid fuel flowing out of a high pressure tank 11 by decompression of the liquid fuel.

Hydrogen gas generated in the reformer 13 flows into the cooling heat exchanger 14. The cooling heat exchanger 14 is used as the cooling unit which cools the hydrogen gas generated in the reformer 13 through heat exchange with engine coolant. The hydrogen gas cooled in the cooling heat exchanger 14 is mixed with intake air, and is supplied as supplemental fuel to a combustion engine through an intake air port of an engine EG. Specifically, the cooling heat exchanger 14 includes a hydrogen gas passage 14a through which hydrogen gas passes, and a coolant passage 21 through which engine coolant circulating in a coolant circuit 20 passes.

In the coolant circuit 20, coolant (e.g., ethylene glycol aqueous solution) which cools the engine EG circulates. The coolant circuit 20 has a loop shape, and circularly connects the above-described coolant passage 21 of the cooling heat exchanger 14, a coolant pump 22, an engine cooling passage 23 provided in the engine EG, and a radiator 24 in this order.

The radiator 24 is used as a coolant cooler which cools the engine coolant through heat exchange with outside air. The coolant pump 22 is an electric pump which pumps the coolant to the engine cooling passage 23 of the engine EG, and a rotation rate (flow amount) of the coolant pump 22 is controlled by a control signal outputted from a system controller not shown in the drawings. When the system controller operates the coolant pump 22, the engine coolant circulates in an order of the coolant pump 22, the engine cooling passage 23 of the engine EG, the radiator 24, the coolant passage 21 of the cooling heat exchanger 14, and then the coolant pump 22.

Thus, the engine coolant heated in the engine cooling passage 23 of the engine EG is cooled in the radiator 24 during flowing therethrough. Subsequently, the cooled engine coolant flows through the coolant passage 21 of the cooling heat exchanger 14, and hydrogen gas passing through the cooling heat exchanger 14 is cooled. Then, the engine coolant passes through the engine cooling passage 23 of the engine EG to cool the engine EG.

In the second embodiment, the cooling heat exchanger 14 cools hydrogen gas through heat exchange with the engine coolant, and is used as the cooling unit which cools hydrogen gas generated in the reformer 13. In this case, the engine cooling system necessary for an engine system of the vehicle can be used as the cooling unit. Therefore, the hydrogen gas to be supplied to the engine EG can be reduced in temperature without an additional energization from outside. Furthermore, a configuration for cooling the hydrogen generated in the reformer 13 can be provided easily and reliably.

In the present embodiment, when the reformer 13 is warmed up before warming up of the engine EG, high-temperature hydrogen gas flowing out of the reformer 13 exchange heat with engine coolant. Therefore, the engine EG can be warmed up rapidly at an early stage after an activation of the engine EG. As a result, a friction loss of the engine EG can be reduced, and fuel efficiency of the vehicle can be thereby improved.

### Third Embodiment

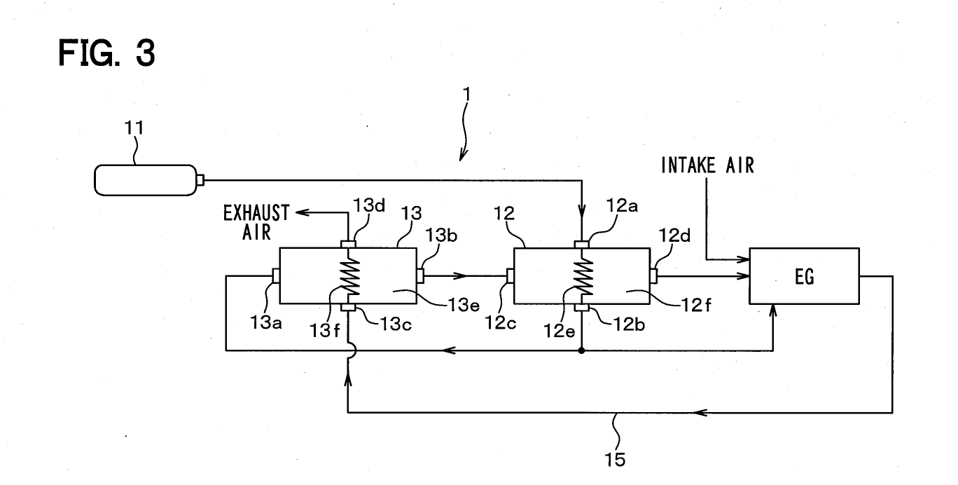

A third embodiment will be described with reference to FIG. 3. The third embodiment is different from the above-described first embodiment in a point where, waste heat of an engine EG is used as the heating means which heats gas fuel to have the fuel-reformable temperature in a reformer 13.

Specifically, a fuel supply system 1 of the third embodiment includes a combustion-gas supply passage 15 which supplies combustion gas generated at the time of combustion of fuel in the engine EG to the reformer 13. Because of the combustion-gas supply passage 15, waste heat generated at the time of the combustion of fuel in the engine EG can be supplied to the reformer 13.

Therefore, the combustion-gas supply passage 15 is used as a waste-heat supply portion which supplies waste heat to the reformer 13.

The reformer 13 of the present embodiment is used as a heat exchanger, in which gas fuel flowing out of a gasifier 12 is heated and decomposed through heat exchange with combustion gas discharged from the engine EG to generate hydrogen.

The reformer 13 includes a gas fuel inflow port 13a connected to a fuel outflow port 12b of the gasifier 12, a hydrogen outflow port 13b connected to hydrogen inflow port 12c of the gasifier 12, and a fuel passage 13e through which the gas fuel introduced into the reformer 13 from the gas fuel inflow port 13a flows. The gas fuel is decomposed along the fuel passage 13e to generate hydrogen.

The reformer 13 further includes a combustion-gas inflow port 13c connected to an outlet side of the combustion-gas supply passage 15, a combustion-gas outflow port 13d connected to outside, and a combustion gas passage 13f through which combustion gas introduced into the reformer 13 from the combustion-gas inflow port 13c flows. In the reformer 13, the combustion gas flowing through the combustion gas passage 13f exchanges heat with the gas fuel flowing through the fuel passage 13e. After the heat exchange between the combustion gas and the gas fuel, the combustion gas is discharged to outside through the combustion-gas outflow port 13d of the reformer 13.

In the combustion gas passage 13f, a combustion catalyst is provided as a combustion portion which combusts uncombusted fuel (ammonia) contained in the combustion gas flowing out of the engine EG.

As described above, in the present embodiment, the waste heat of the engine EG is used as the heating means which heats the reformer 13. Therefore, gas fuel can be decomposed in the reformer 13 to generate hydrogen gas without additional energization from outside.

Moreover, in the present embodiment, gas fuel is decomposed by using the waste heat of the engine EG, i.e., heat of the combustion gas. Thus, fuel to be supplied to the reformer 13 need not be oxidized (burned) partially to generate heat for decomposition of the fuel (as in the case of the conventional technology described above). As a result, reduction of an efficiency of the engine EG due to the oxidization of the fuel before supply of the fuel to the engine EG can be limited.

In the present embodiment, fuel is not combusted in the fuel passage 13e of the reformer 13. Hence, supply of water vapor or nitrogen, which is generally generated in oxidization of fuel, into the engine EG can be limited. Therefore, a compression ratio of the engine EG can be increased, and the efficiency of the engine EG can be thereby improved.

Additionally, in the present embodiment, the combustion catalyst is provided in the combusted-gas passage 13f of the reformer 13 as the combustion portion which combusts uncombusted fuel contained in the combustion gas.

Even when fuel is not combusted sufficiently in the engine EG, uncombusted fuel contained in the combustion gas can be burned in the combustion gas passage 13f in which the combustion catalyst is provided. Therefore, even when fuel is not combusted sufficiently in the engine EG, the reformer 13 can be heated sufficiently. Consequently, a necessary heat to reform gas fuel in the reformer 13 can be supplied to the reformer 13.

In the present embodiment, high-temperature combustion gas generated in the engine EG is supplied to the combustion gas passage 13f of the reformer 13. In other words, the high-temperature combustion gas generated in the engine EG is supplied to the combustion catalyst used as the combustion portion. Hence, in the combustion gas passage 13f where the combustion catalyst is disposed, the high-temperature combustion gas can be further increased in temperature. Therefore, a higher temperature combustion gas can be supplied to the reformer 13.

### Fourth Embodiment

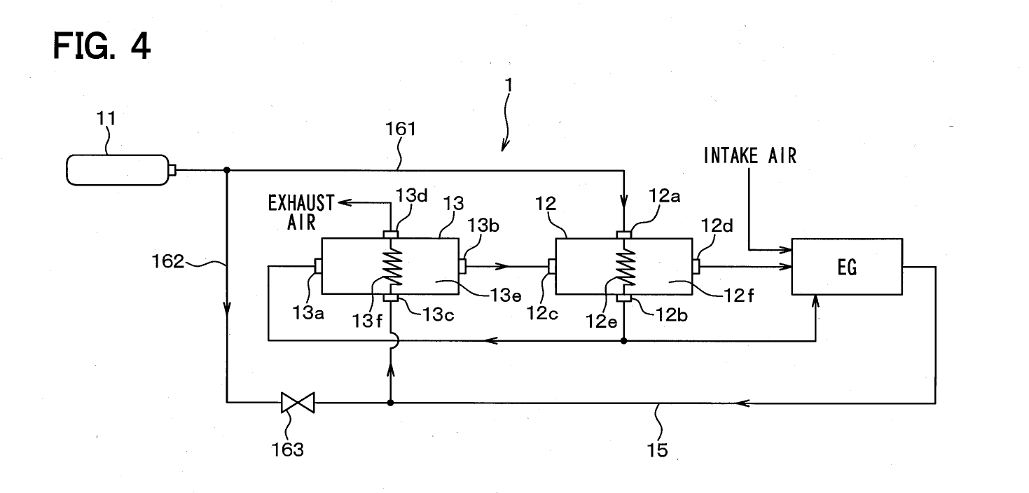

A fourth embodiment will be described referring to FIG. 4. The fourth embodiment is different from the above-described third embodiment in a point where a fuel supply system 1 of the fourth embodiment includes a fuel mixing portion which mixes fuel with combustion gas.

In the fourth embodiment, a flow of liquid fuel out of a high pressure tank 11 is divided into two flows, as shown in FIG. 4. One of the branched two flows of the liquid fuel is directed to enter into a gasifier 12, and the other one of the two flows of the liquid fuel is directed to enter into a combustion-gas supply passage 15.

Here, a flow passage, through which the one of the two branched flows of the liquid fuel joins the gasifier 12, is referred to as a gasifier-side liquid fuel passage 161. On the other hand, a flow passage, through which the other one of the two flows of the liquid fuel meets the combustion-gas supply passage 15, is referred to as a mixing-side liquid fuel passage 162. An outlet side of the gasifier-side liquid fuel passage 161 is connected to a fuel inflow port 12a of the gasifier 12.

An outlet side of the mixing-side liquid fuel passage 162 is connected to the combustion-gas supply passage 15. Thus, liquid fuel flowing out of the high temperature tank 11 flows through the mixing-side liquid fuel passage 162 to be mixed with combustion gas flowing in the combustion-gas supply passage 15. Therefore, the mixing-side liquid fuel passage 162 may correspond to the fuel mixing portion which mixes the liquid fuel flowing out of the high pressure tank 11 with the combustion gas flowing in the combustion-gas supply passage 15.

More specifically, the outlet of the mixing-side liquid fuel passage 162 is connected to an upstream side of a combustion gas passage 13f of the reformer 13, in which a combustion catalyst is disposed as the combustion portion. In other words, the outlet side of the mixing-side liquid fuel passage 162 is connected to an upstream side of the combustion catalyst used as the combustion portion. Therefore, liquid fuel flowing out of the mixing-side liquid fuel passage 162 is mixed with the combustion gas on an upstream side of the combustion catalyst in a flow direction of the combustion gas.

In the mixing-side liquid fuel passage 162, a first electromagnetic valve 163 is provided as an open-close portion which opens or closes the mixing-side liquid fuel passage 162. An operation of the first electromagnetic vale 163 is controlled by a control voltage outputted from a non-shown system controller. Therefore, by adjusting an opening time length of the first electromagnetic valve 163, a flow amount of fuel supplied to the combustion-gas supply passage 15 can be adjusted.

In the present embodiment, even when the combustion gas generated in the engine EG contains little uncombusted fuel, fuel can be mixed with the combustion gas flowing in the combustion-gas supply passage 15 via the mixing-side liquid fuel passage 162. In this case, fuel can be burned in the combustion gas passage 13f where the combustion catalyst is disposed, and a necessary heat for reforming of the fuel in the reformer 13 can be thereby supplied to the reformer 13.

Generally, fuel stored in the high pressure tank 11 is in a pressurized state, and a pressure of outside air has an atmosphere pressure. Hence, the pressure of fuel is higher than the combustion gas pressure, which is higher than the air pressure (air<combustion gas<fuel). In the present embodiment, fuel is mixed into the combustion-gas supply passage 15 through which the combustion gas discharged from the engine EG flows. Therefore, a backflow of fuel is easy to prevent, and a delicate control of a mixed amount of fuel can be thereby performed easily, as compared with a configuration where air is mixed into a fuel supply passage through which fuel is supplied to an engine.

### Fifth Embodiment

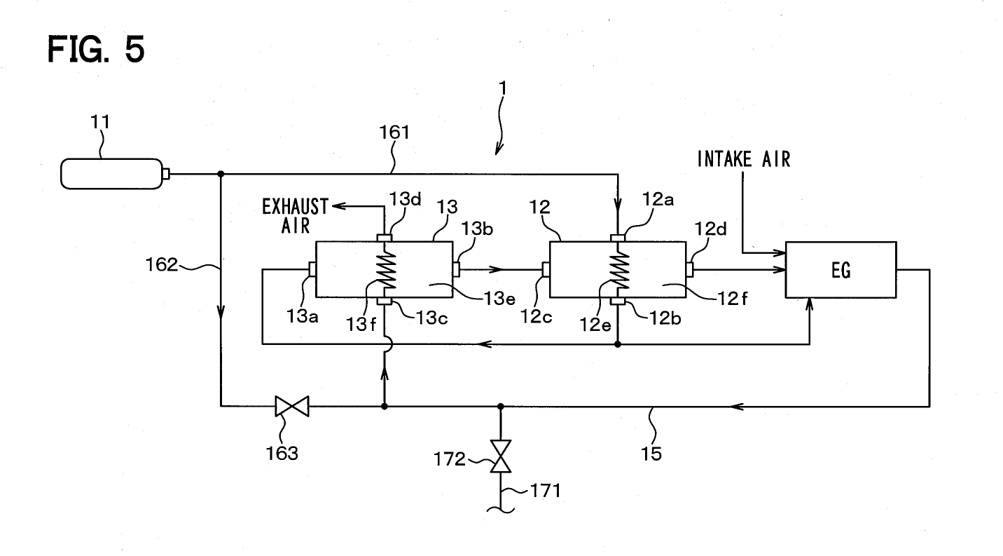

A fifth embodiment will be described in reference to FIG. 5. The fifth embodiment is different from the above-described fourth embodiment in a point where a fuel supply system 1 includes an oxygen supply portion which supplies oxygen necessary for combustion of uncombusted fuel contained in combustion gas in a combustion catalyst in a reformer 13.

A combustion-gas supply passage 15 of the present embodiment is connected to an air mixing passage 171 through which air is mixed with combustion gas flowing in the combustion-gas supply passage 15. The air mixing passage 171 is connected to a part of the combustion-gas supply passage 15 located upstream of a connection part between the combustion-gas supply passage 15 and a mixing-side liquid fuel passage 162 in a flow direction of the combustion gas. In other words, a connection part between the combustion-gas supply passage 15 and the air mixing passage 171 is located upstream of the combustion catalyst in the reformer 13 in the flow direction of the combustion gas. Thus, oxygen necessary for combustion of uncombusted fuel contained in the combustion gas at the combustion catalyst in the reformer 13 can be supplied to the reformer 13 by mixing air with the combustion gas via the air mixing passage 171. Therefore, the air mixing passage 171 may correspond to the oxygen supply portion.

In the air mixing passage 171, a second electromagnetic valve 172 is provided as an open-close portion which opens or closes the air mixing passage 171. An operation of the second electromagnetic valve 172 is controlled by a control voltage outputted from a non-shown system controller. Thus, by adjusting an open time length of the second electromagnetic valve 172, a flow amount of air supplied to the combustion-gas supply passage 15 can be adjusted.

In the present embodiment, even when combustion gas generated in an engine EG contains little oxygen, air (oxygen) can be mixed with the combustion gas flowing in the combustion-gas supply passage 15 via the air mixing passage 171. In this case, the uncombusted fuel can be burned in the combustion gas passage 13f where the combustion catalyst is disposed, and a necessary heat to reform the fuel in the reformer 13 can be thereby supplied to the reformer 13.

In the present embodiment, air is supplied to the combustion-gas supply passage 15 through which combustion gas discharged from the engine EG flows. Because the fuel supply system 1 of the present embodiment does not have a configuration where air is supplied to a fuel supply passage through which fuel is supplied to an engine, water vapor or nitrogen is not mixed into fuel that is to be supplied to the engine EG. Therefore, a compression ratio of the engine EG can be increased, and an efficiency of the engine EG can be thus improved.

### Sixth Embodiment

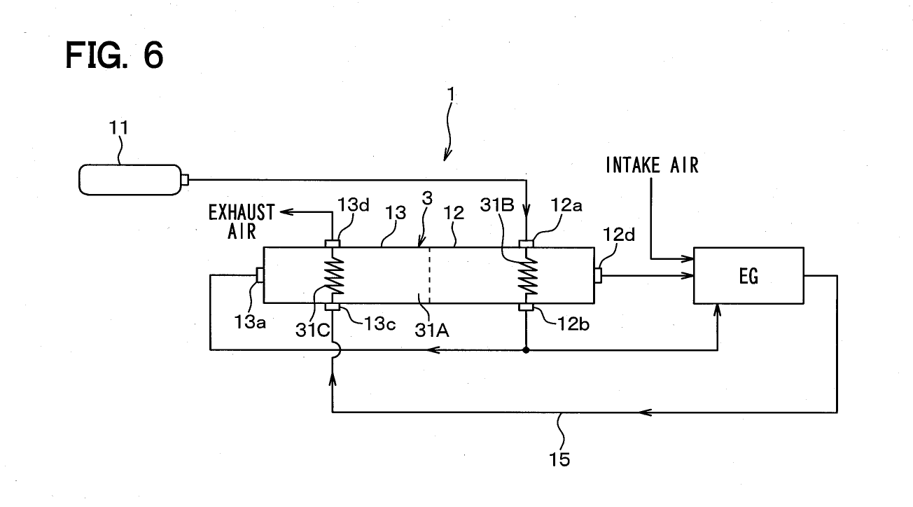

A sixth embodiment will be described referring to FIGS. 6 to 8. The sixth embodiment is different from the above-described third embodiment in a point where a gasifier 12 and a reformer 13 are integrated with each other as a single heat exchanger 3.

A fuel supply system 1 of the sixth embodiment includes the single heat exchanger 3 in which the gasifier 12 and the reformer 13 are integrated.

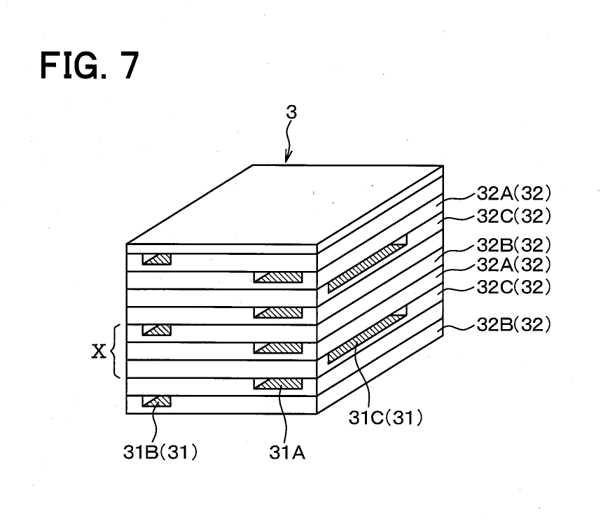

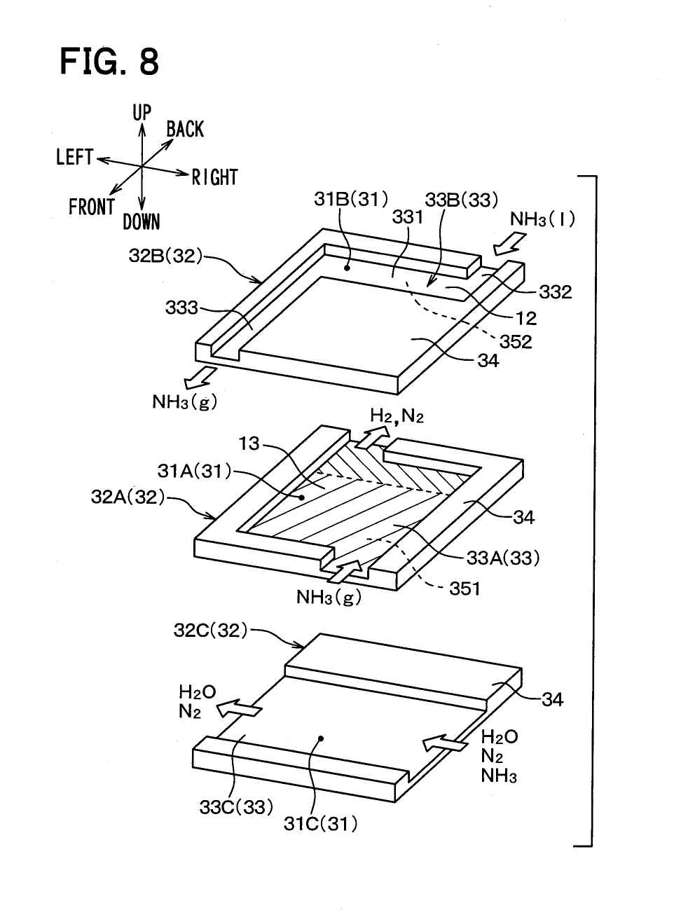

The heat exchanger 3 of the present embodiment is a micro-channel type, and includes a core portion in which heat exchange is performed. As shown in FIG. 7, the core portion includes multiple plate members 32 which are stacked, and each of the plate members 32 has a heat-medium passage 31 through which a heat medium, such as liquid fuel, gas fuel, or combustion gas, flows. As shown in FIG. 8, each of the plate members 32 has a groove part 33 which defines the heat-medium passage 31. A part of each plate member 32 other than the groove part 33 is a wall part 34.

The core portion of the heat exchanger 3, in which heat exchange is performed, is obtained by assembling in following steps, for example. Firstly, the groove parts 33 are provided in the plate members 32 respectively. Secondly, the plate members 32 are stacked such that an upper plate member 32 is placed on a wall part 34 of a lower plate member 32. Lastly, the upper plate member 32 and the wall part 34 of the lower plate member 32 are joined to each other. Here, each of the above-described heat-medium passage 31 is defined by a groove part 33 and a plate member 32 arranged above the groove part 33. In other words, the heat-medium passage 31 is defined by a pair of plate members 32 in a vertical direction and by a pair of wall parts 34 in a horizontal direction.

Specifically, the heat exchanger 3 includes three types of the plate members 32, which are a gas fuel plate 32A, a liquid fuel plate 32B, and a combustion gas plate 32C.

The gas fuel plate 32A is interposed between the liquid fuel plate 32B and the combustion gas plate 32C. The gas fuel plate 32A includes a gas fuel groove 33A defining a gas fuel passage 31A in which gas fuel flows and is decomposed to generate hydrogen.

The liquid fuel plate 32B is arranged on one side of the gas fuel plate 32A in a stacking direction of the plate members 32, and the stacking direction is referred to as a plate stacking direction hereinafter. In FIG. 8, the liquid fuel plate 32B is arranged an upper side of the gas fuel plate 32A. The liquid fuel plate 32B includes a liquid fuel groove 33B defining a liquid fuel passage 31B in which liquid fuel flows to be heated and gasified.

The combustion gas plate 32C is arranged the other side of the gas fuel plate 32A in the plate stacking direction. In FIG. 8, the combustion gas plate 32C is arranged under the gas fuel plate 32A. The combustion gas plate 32C includes a combustion gas groove 33C defining a combustion gas passage 31C through which combustion gas flows. A combustion catalyst (not shown) is disposed in the combustion gas passage 31C, and uncombusted fuel contained in the combustion gas is burned in the combustion gas passage 31C. Therefore, the combustion gas passage 31C may correspond to the combustion portion.

The gas fuel groove 33A occupies almost an entire area of an upper surface of the gas fuel plate 32A, as shown in FIG. 8. The gas fuel groove 33A is configured such that the gas fuel passage 31A is connected to a gas fuel inflow port 13a (see FIG. 6) on a front side in FIG. 8, and that the gas fuel passage 31A is connected to a hydrogen outflow port 12d (see FIG. 6) on a back side in FIG. 8. Therefore, a flow direction of gas fuel flowing in the gas fuel groove 33A is thereby approximately same as a front-to-back direction in FIG. 8.

A main part 331 of the liquid fuel passage 31B occupies a back area of an upper surface of the liquid fuel plate 32B in FIG. 8. The main part 331 extends in a right-left direction in FIG. 8.

The liquid fuel passage 31B has an inflow part 332 located on a back side of the main part 331 in FIG. 8, and the inflow part 332 connects together the main part 331 and a fuel inflow port 12a (see FIG. 6). A dimension of the inflow part 332 in the right-left direction is smaller than a dimension of the main part 331 in the right-left direction in FIG. 8. For example, the dimension of the inflow part 332 in the right-left direction is equal to or smaller than a half of the dimension of the main part 331 in the right-left direction.

The liquid fuel passage 31B has an outflow part 333 located on a front side of the main part 331 in FIG. 8, and the outflow part 333 connects together the main part 331 and a fuel outflow port 12b (see FIG. 6). A dimension of the outflow part 333 in the right-left direction is smaller than the dimension of the main part 331 in the right-left direction in FIG. 8. For example, the dimension of the outflow part 333 in the right-left direction is equal to or smaller than the half of the dimension of the main part 331 in the right-left direction.

The inflow part 332 is connected to an end portion of the main part 331 on one side in the right-left direction, and the outflow part 333 is connected to an end portion of the main part 331 on the other side in the right-left direction. Therefore, a flow direction of liquid fuel flowing in the main part 331 is approximately same as the right-to-left direction in FIG. 8.

The combustion gas groove 33C occupies a front area of an upper surface of the combustion gas plate 32C as shown in FIG. 8. The combustion gas groove 33C is configured such that the combustion gas passage 31C is connected to a combustion-gas inflow port 13c (see FIG. 6) on a right side in FIG. 8, and that the combustion gas passage 31C is connected to a combustion-gas outflow port 13d (see FIG. 6) on a left side in FIG. 8.

As described above, the combustion gas groove 33C occupies the front area of the upper surface of the combustion gas plate 32C in FIG. 8. Thus, heat of combustion gas flowing in the combustion gas passage 31C is transferred only to a part of the gas fuel passage 31A adjacent to the combustion gas passage 31C, i.e., a part of the gas fuel passage 31A which overlaps the combustion gas passage 31C when viewed in the plate stacking direction. The part of the gas fuel passage 31A adjacent to the combustion gas passage 31C, i.e., the part of the gas fuel passage 31A which overlaps the combustion gas passage 31C when viewed in the plate stacking direction is shown by diagonal lines from bottom left to top right in FIG. 8, and is referred to as an upstream part.

Thus, the gas fuel plate 32A has a first heat transfer portion 351 between the upstream part of the gas fuel passage 31A and the combustion gas passage 31C. The first heat transfer portion 351 transfers heat of combustion gas flowing in the combustion gas passage 31C to gas fuel flowing in the upstream part of the gas fuel passage 31A.

In this case, the upstream part of the gas fuel passage 31A may correspond to the reformer 13 which heats gas fuel via heat exchange with combustion gas to decompose the gas fuel and to generate hydrogen gas. Moreover, because the gas fuel flowing in the upstream part of the gas fuel passage 31A is heated by using heat of the combustion gas flowing in the combustion gas passage 31C, the combustion gas passage 31C is used as the heating means which heats the gas fuel to the fuel-reformable temperature.

As described above, the liquid fuel groove 33B occupies the back area of the upper surface of the liquid fuel plate 32B in FIG. 8. Thus, heat of hydrogen gas flowing only in a part of the gas fuel passage 31A adjacent to the main part 331 of the liquid fuel passage 31B is transferred to liquid fuel flowing in the main part 331 of the liquid fuel passage 31B. In other words, the heat of hydrogen gas flowing only in a part of the gas fuel passage 31A, which overlaps the main part 331 of the liquid fuel passage 31B when viewed in the plate stacking direction, is transferred to the liquid fuel flowing in the main part 331 of the liquid fuel passage 31B. The part of the gas fuel passage 31A adjacent to the main part 331 of the liquid fuel passage 31B, i.e., the part of the gas fuel passage 31A which overlaps the main part 331 of the liquid fuel passage 31B when viewed in the plate stacking direction is shown by diagonal lines from top left to bottom right in FIG. 8, and is referred to as a downstream part.

Thus, the liquid fuel plate 32B has a second heat transfer portion 352 between the downstream part of the gas fuel passage 31A and the main part 331 of the liquid fuel passage 31B. The second heat transfer portion 352 transfers heat of hydrogen gas flowing in the downstream part of the gas fuel passage 31A to liquid fuel flowing in the main part 331 of the liquid fuel passage 31B.

In the main part 331 of the liquid fuel passage 31B, the liquid fuel is heated and gasified through heat exchange with the hydrogen gas. Therefore, the main part 331 of the liquid fuel passage 31B may correspond to the gasifier 12.

When the liquid fuel is gasified in the main part 331 of the liquid fuel passage 31B, latent heat of vaporization of the liquid fuel is absorbed from the hydrogen gas flowing in the downstream part of the gas fuel passage 31A. Accordingly, the hydrogen gas is cooled. Therefore, the main part 331 of the liquid fuel passage 31B is used also as the cooling unit which cools hydrogen gas.

As described above, because the reformer 13 and the gasifier 12 are integrated into the single heat exchanger 3, the reformer 13 and the gasifier 12 can be downsized. Moreover, a pipe connecting the reformer 13 and the gasifier 12 can be omitted, and heat loss, such as heat release from the pipe, can be thereby prevented.

In the present embodiment, the gas fuel plate 32A has the first heat transfer portion 351 between the upstream part of the gas fuel passage 31A and the combustion gas passage 31C to transfer heat of combustion gas to gas fuel, and the liquid fuel plate 32B has the second heat transfer portion 352 between the downstream part of the gas fuel passage 31A and the main part 331 of the liquid fuel passage 31B to transfer heat of hydrogen gas to liquid fuel.

Thus, the heat exchanger 3 is configured such that the first heat transfer portion 351 and the second heat transfer portion 352 do not overlap each other when viewed in the plate stacking direction. In other words, the heat exchanger 3 is configured such that a vector of heat flux in the first heat transfer portion 351 and a vector of heat flux in the second heat transfer portion 352 do not overlap each other.

Accordingly, in the micro-channel type heat exchanger 3, heat exchange can performed selectively between combustion gas and gas fuel, and between liquid fuel and hydrogen gas.

The present disclosure is not limited to the above-described embodiments, and the embodiments can modified variedly as follow without departing from the scope of the present disclosure.

In the above-described second embodiment, the radiator 24, in which outside air and coolant exchange heat with each other, is provided as the coolant cooler which cools the engine coolant, but the coolant cooler is not limited to the radiator 24. For example, a gasifier, which cools coolant and heats liquid fuel to gasify the liquid fuel through heat exchange between the coolant and the liquid fuel, may be used as the coolant cooler. Alternatively, a heater core of a vehicle air conditioner, which cools coolant and heats air blown to a vehicle compartment through heat exchange between the coolant and the blown air, may be used as the coolant cooler.

In the above-described third embodiment, the fuel passage 13e and the combustion gas passage 13f are provided in the reformer 13 as the heating means which heats gas fuel to the fuel-reformable temperature, and gas fuel flowing in the fuel passage 13e is heated by using heat of combustion gas flowing through the combustion gas passage 13f. In other words, in the above-described third embodiment, the configuration, in which the combustion-gas passage 13f is provided separately from the fuel passage 13e so as to prevent the combustion gas from mixing into the gas fuel, is adopted as the heating means. However, the heating means is not limited to such configuration. For example, a configuration, in which combustion gas and fuel flow in a flow passage so as to mix with each other in a reformer 13, may be adopted as the heating means.

In the above-described third embodiment, the combustion catalyst is provided in the combustion gas passage 13f of the reformer 13 as the combustion portion which combusts uncombusted fuel contained in combustion gas, but the combustion portion is not limited to this. For example, a combustion catalyst may be provided in the combustion-gas supply passage 15, or a burner may be provided in the combustion-gas supply passage 15 as the combustion portion. Moreover, the combustion portion may be omitted.

In the above-described fifth embodiment, the air mixing passage 171 is adopted as the oxygen supply portion which supplies a necessary amount of oxygen to combust uncombusted fuel contained in combustion gas at the combustion catalyst in the reformer 13, but the oxygen supply portion is not limited to the air mixing passage 171. For example, a configuration, in which the system controller controls an air-fuel ratio in the engine EG to be fuel-lean to increase an oxygen amount contained in combustion gas discharged from the engine EG, may be adopted as the oxygen supply portion.

In the above-described sixth embodiment, the combustion catalyst is provided in the combustion gas passage 31C of the heat exchanger 3 as the combustion portion which combusts uncombusted fuel contained in combustion gas, but the combustion portion is not limited to this. For example, a combustion catalyst may be provided in the combustion-gas supply passage 15, or a burner may be provided in the combustion-gas supply passage 15 as the combustion portion. Moreover, the combustion portion may be omitted.

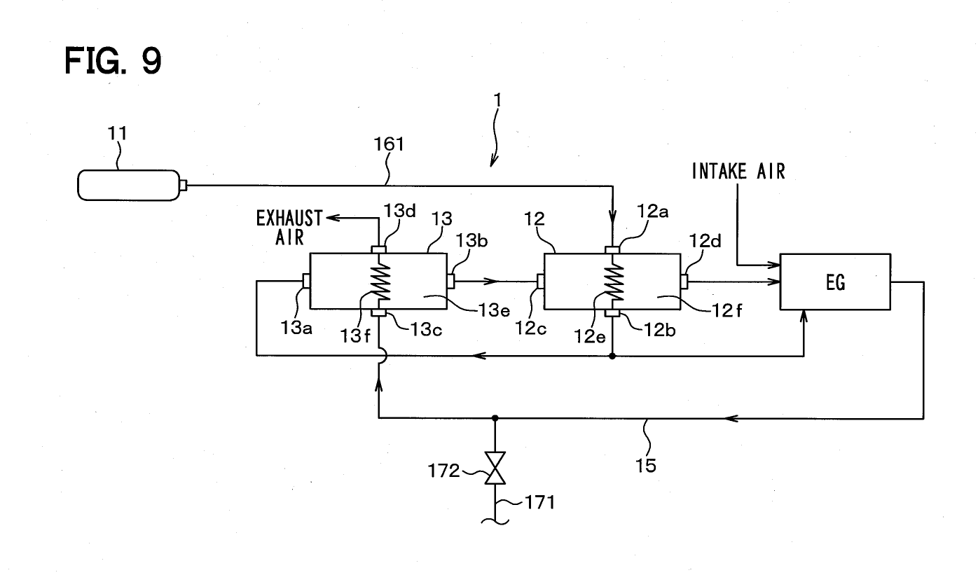

The above-described embodiments can be combined with each other arbitrarily within a possible range. For example, as shown in FIG. 9, the air mixing passage 171 described in the fifth embodiment may be combined with the fuel supply system 1 of the third embodiment.

While the present disclosure has been described with reference to embodiments thereof, it is to be understood that the disclosure is not limited to the embodiments and configurations. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A fuel supply system comprising:
an energy output device configured to consume fuel, which is a compound including hydrogen, and to output energy;
a reformer configured to decompose fuel so as to generate hydrogen which is to be supplied to the energy output device; and
a cooling unit configured to cool the hydrogen generated in the reformer.

2. The fuel supply system according to claim 1, further comprising a liquid-fuel storage portion that accumulates therein fuel in a high-pressure liquid state, wherein:
the cooling unit includes a gasifier configured to gasify the high-pressure liquid fuel flowing out of the liquid-fuel storage portion and to supply the gasified fuel to the reformer;
the reformer decomposes the fuel gasified by the gasifier so as to generate hydrogen; and
the cooling unit cools the hydrogen generated in the reformer by use of latent heat of vaporization of fuel by the gasifier.

3. The fuel supply system according to claim 2, wherein the energy output device outputs mechanical energy by combusting fuel, the system further comprising a waste-heat supply portion configured to supply the reformer with waste heat generated at time of the combustion of fuel in the energy output device.

4. The fuel supply system according to claim 3, wherein the waste-heat supply portion includes a combustion-gas supply passage through which combustion gas generated at the time of the combustion of fuel in the energy output device is supplied to the reformer, the system further comprising a combustion portion configured to combust fuel, which is left uncombusted at the time of the combustion of fuel in the energy output device and included in combustion gas.

5. The fuel supply system according to claim 4, further comprising a fuel mixing portion configured to mix the fuel flowing out of the liquid-fuel storage portion with the combustion gas flowing through the combustion-gas supply passage.

6. The fuel supply system according to claim 5, further comprising an oxygen supply portion configured to supply the combustion portion with oxygen, which is necessary for the combustion portion to combust the uncombusted fuel included in the combustion gas.

7. The fuel supply system according to claim 4, further comprising an oxygen supply portion configured to supply the combustion portion with oxygen, which is necessary for the combustion portion to combust the uncombusted fuel included in the combustion gas.

8. The fuel supply system according to claim 4, wherein the reformer, the gasifier and the combustion portion are integrated into a single heat exchanger.

9. The fuel supply system according to claim 8, wherein the heat exchanger includes:
a liquid fuel passage through which liquid fuel flows to be gasified;
a gas fuel passage through which gas fuel flows to be decomposed so as to generate hydrogen;
a combustion gas passage through which combustion gas flows;
a first heat transfer portion arranged between the gas fuel passage and the combustion gas passage to transfer heat of combustion gas to gas fuel; and
a second heat transfer portion arranged between the liquid fuel passage and the gas fuel passage to transfer heat of hydrogen to liquid fuel.

10. The fuel supply system according to claim 2, wherein the reformer and the gasifier are integrated into a single heat exchanger.

11. The fuel supply system according to claim 1, wherein the cooling unit includes a cooling heat exchanger configured to cool hydrogen, which is generated in the reformer, via heat exchange with a heat medium.

12. The fuel supply system according to claim 1, wherein the fuel is ammonia.
